(19) United States
(12) Patent Application Publication
(10) Pub. No.: US 2009/0214073 A1
(43) Pub. Date: Aug. 27, 2009

(54) Adjustable Ear-Hook Earphone with Compressible Inner Portion and Related Methods

(75) Inventor: Karin Anna Sandberg, Vellinge (SE)

Correspondence Address: MYERS BIGEL SIBLEY & SAJOVEC, PO BOX 37428, RALEIGH, NC, 27627, US

(73) Assignee: Sony Ericsson Mobile Communications AB

(21) Appl. No.: 12/036,491

(22) Filed: Feb. 25, 2008

(51) Int. Cl. H04R 25/02

(52) U.S. Cl. 381/381

(57) ABSTRACT

An adjustable ear-hook earphone includes an audio earphone and a substantially auriform ear-hook connected to the earphone and configured to engage an ear of a user to hold the earphone adjacent the ear. The ear-hook has an outer portion configured to face generally away from the ear and a compressible inner portion configured to face generally toward the ear. The inner portion is compressible between a compressed position and a plurality of successive, expanded positions such that the expanded positions exert a force on the ear of the user.

### FIELD OF THE INVENTION

The present invention relates to earphones, and in particular, to ear-hook earphones worn over the ear.

### BACKGROUND

Ear-hook earphones typically include a C-shaped hook that attaches to the user's ear in an over-the-ear configuration. The hook is typically connected to a speaker housing such that the hook holds the speaker housing in position adjacent the ear of the user. In some cases, a microphone can also be attached to the hook so that both earphone and microphone capabilities are provided in a single device.

However, over-the-ear configuration ear-hook earphones are typically made in one size that may not fit or feel comfortable for a wide range of user ear sizes and shapes.

### SUMMARY OF EMBODIMENTS OF THE INVENTION

According to embodiments of the present invention, an adjustable ear-hook earphone includes an audio earphone and a substantially auriform ear-hook connected to the earphone and configured to engage an ear of a user to hold the earphone adjacent the ear. The ear-hook has an outer portion configured to face generally away from the ear and a compressible inner portion configured to face generally toward the ear. The inner portion is compressible between a compressed position and a plurality of successive, expanded positions such that the expanded positions exert a force on the ear of the user.

In some embodiments, the outer portion of the ear-hook is substantially rigid. The inner portion can be configured to expand to one of the plurality of successive, expanded positions to substantially conform the earhook to more than one differently sized ear.

In some embodiments, the outer portion is formed of a first material and the inner portion is formed of a second material that is different from the first material. The second material can be foam.

In particular embodiments, the audio earphone is configured to communicate with a cellular phone. In some embodiments, the audio earphone includes a speaker.

In some embodiments, the inner portion includes an elongated member that extends along a length substantially parallel to the outer portion of the ear-hook. The inner portion can be configured to compress and expand in a direction substantially normal to the ear-hook.

According to some embodiments of the present invention, an adjustable ear-hook assembly includes a substantially auriform ear-hook configured to be connected to an earphone housing and further configured to engage an ear of a user to hold the earphone adjacent the ear. The ear-hook has an outer portion configured to face generally away from the ear and a compressible inner portion configured to face generally toward the ear. The inner portion is compressible between a compressed position and a plurality of successive, expanded positions such that the expanded positions exert a force on the ear of the user.

According to further embodiments of the present invention, methods for adjusting an adjustable ear-hook include providing a substantially auriform ear-hook having an outer portion configured to face generally away from an ear of the user and a compressible inner portion configured to face generally toward the ear. The inner portion of the ear-hook is compressed. The ear of the user is engaged with the ear-hook such that the inner portion automatically expands from a compressed position to an expanded position that exerts a force on the ear of the user and conforms the ear-hook to the ear.

In particular embodiments, the outer portion of the ear-hook is substantially rigid. The inner portion can be configured to automatically expand to one of the plurality of successive, expanded positions to substantially conform the earhook to more than one differently sized ear.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a perspective view of an adjustable ear-hook earphone with a compressible inner portion according to embodiments of the present invention.

FIG. 2 is a perspective view of the adjustable ear-hook earphone of FIG. 1 shown in use on the ear of a user.

FIG. 3 is a side perspective view of the adjustable ear-hook earphone of FIG. 1 with the compressible inner portion of the ear-hook in a partially compressed position.

FIG. 4 is a side perspective view of the adjustable ear-hook earphone of FIG. 1 with the compressible inner portion of the ear-hook a second partially compressed position.

FIG. 5 is a side perspective view of an adjustable ear-hook earphone with a compressible inner portion according to farther embodiments of the present invention shown in a generally uncompressed position.

FIG. 6 is a side perspective view of the adjustable ear-hook earphone of FIG. 5 shown in a generally compressed position.

FIG. 7 is a flow chart illustrating operations according to embodiments of the present invention.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

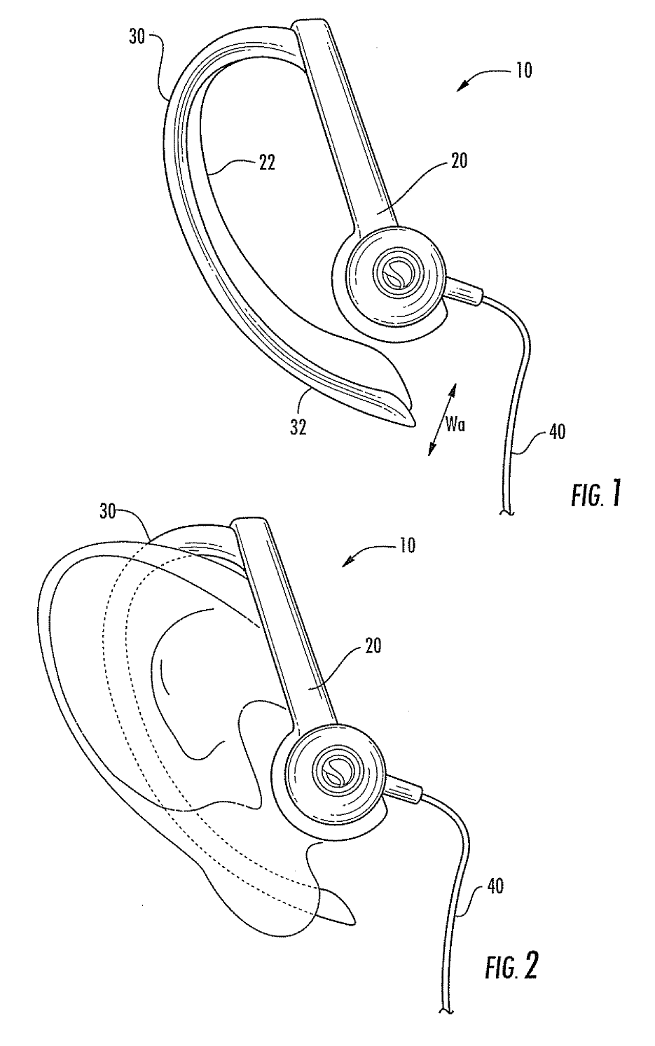

As illustrated in FIGS. 1-4, an adjustable ear-hook earphone 10 includes an earphone housing 20 connected to an auriform ear-hook 30, and an optional wired connection 40. The ear-hook 30 includes an outer portion 32 and a compressible inner portion 34.

As illustrated in FIG. 2, the ear-hook 30 is configured to engage an ear of a user to hold the earphone housing 20 adjacent the ear. The earphone housing 20 can include conventional earphone electronics, such as a speaker, a microphone, an antenna and/or other communication electronics. The outer portion 32 of the ear-hook 30 is configured to face generally away from the ear, and the compressible inner portion 34 is configured to face generally toward the ear.

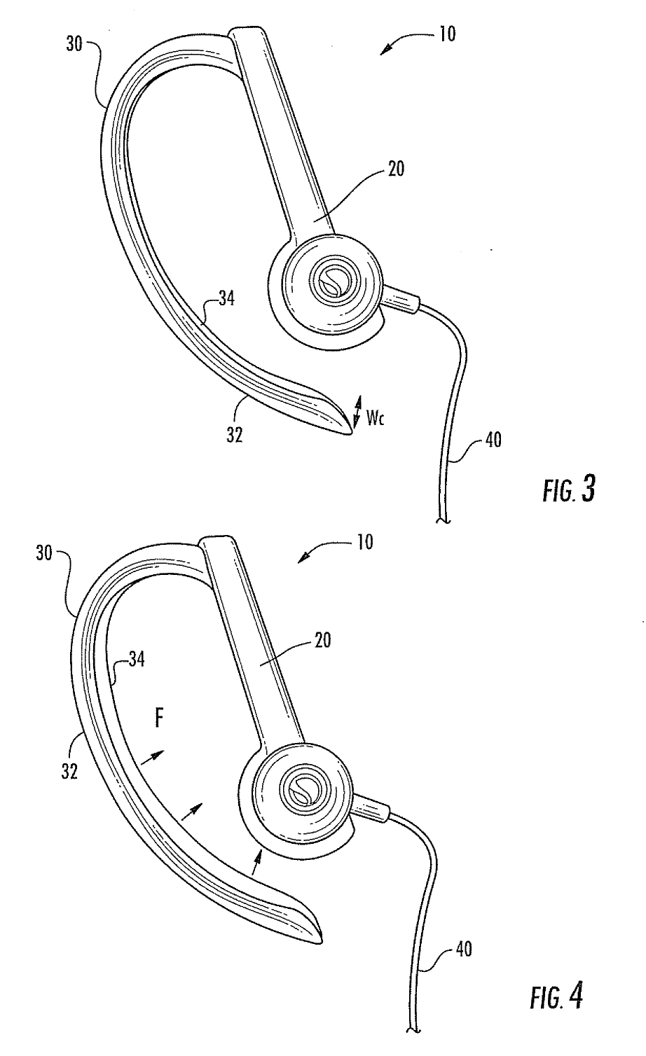

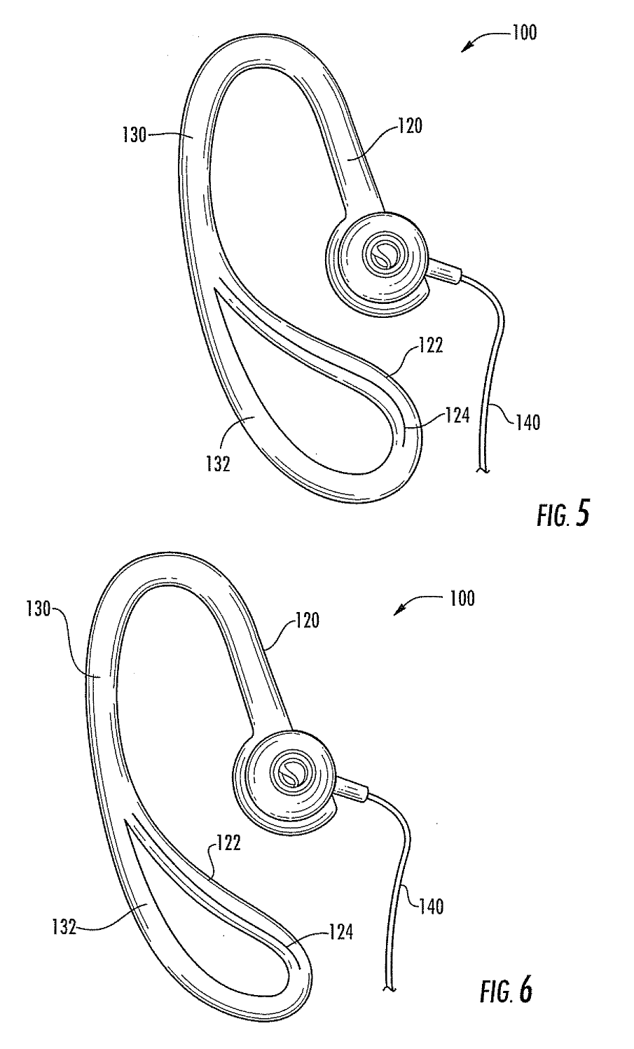

As shown in FIG. 1, the inner portion 34 of the ear-hook 30 is in an expanded position without an opposing force on the inner portion 34 to cause compression. In FIG. 3, the inner portion 34 of the ear-hook 30 is shown in a compressed position, for example, as may occur when a user exerts a force on the ear-hook 30. In some embodiments, the inner portion 34 of the ear hook is compressed when a user pushes the ear-hook 30 on the ear without the user necessarily exerting a separate force on the ear-hook 30 to compress the inner portion 34. In other words, movement of the ear-hook 30 over the ear can exert a compressive force on the inner portion 34. In FIG. 4, the inner portion 34 of the ear-hook 30 is shown in a partially expanded position, e.g., as may occur when the user releases the ear-hook 30 in position on the ear (FIG. 2) so that the inner portion 34 automatically expands to one of the plurality of expanded positions to exert a force F on the ear of the user and to substantially conform the ear-hook 30 to the ear of the user. Accordingly, the inner portion 32 is compressible between a compressed position (FIG. 3) and a plurality of successive, expanded positions such that the expanded positions exert a force F on the ear of the user (FIG. 4) when the ear-hook is in position on the ear (FIG. 2).

In this configuration, the shape of the ear-hook 30 is automatically adjusted for users having differently sized ears so that the plurality of successive, expanded positions substantially conform the ear-hook 30 to more than one differently sized ear. In some embodiments, the outer portion 32 of the ear-hook 30 is substantially rigid, e.g., so that the force of the expansion of the compressible inner portion 32 is directed primarily on the ear of the user rather than resulting in a deformation of the outer portion 32 of the ear-hook 30.

In some embodiments, the outer portion 32 can be formed of a different material than the material used to form the inner portion 34. The outer portion 32 can be formed of a material that is substantially rigid and/or non-deformable to provide structure and/or support for the ear-hook 30 and the compressible inner portion 34. The inner portion 34 can be formed of a compressible material, such as a softer foam or foam-like material such as TEMPUR® material or other suitable compressible materials, can be used. As illustrated in FIGS. 1-4, the inner portion 34 is a generally elongated member that extends along a length substantially parallel to the outer portion 32 of the ear-hook 30. The inner portion 34 is configured to expand and compress in a direction that is substantially normal to the ear-hook 30.

As illustrated in FIG. 1, the inner portion 34 of the ear-hook 30 has a width wᵤ in an uncompressed position. As shown in FIG. 3, the inner portion 34 of the ear-hook 30 has a width w_{c} in a compressed position. In particular embodiments, the width wᵤ is between about 1 and 20 mm, and the width w_{c} is between about 0.5 mm or less and 10 mm.

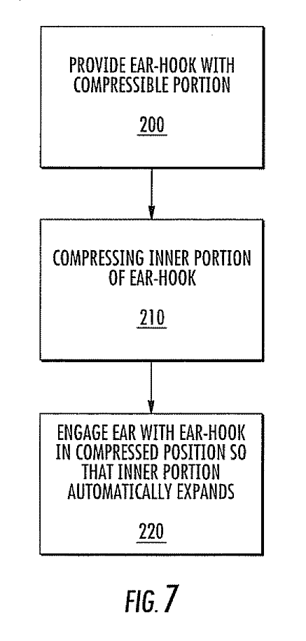

Although embodiments of the earphone are illustrated with respect to the earphone 10 in FIGS. 1-4, it should be understood that any suitable configuration can be used without departing from the scope of the invention. For example, as illustrated in FIGS. 5-6, an adjustable ear-hook earphone 100 includes an earphone housing 120 connected to an auriform ear-hook 130. The ear-hook 130 includes a relatively stiff outer portion 132 and a compressible inner portion 134.

The ear-hook 130 is configured to engage an ear of a user to hold the earphone housing 120 adjacent the ear, for example, as shown in FIG. 2 with respect to the earphone 10. The outer portion 132 of the ear-hook 130 is configured to face generally away from the ear, and the compressible inner portion 134 is configured to face generally toward the ear.

As illustrated in FIGS. 5-6, the compressible inner portion 134 of the ear-hook 100 includes a spring member 124 enclosed in a sheath 122. The spring member 124 can be formed of metal or other shape memory material, such as polyoxymethylene (POM), and the sheath 122 can be any suitable material, such as an elastomer, rubber or other material.

When no force is exerted on the spring member 124, the ear-hook 100 is in a generally expanded position as shown in FIG. 5. When the spring member 124 is compressed, the inner portion 134 of the ear-hook 100 is pressed closer to the outer portion 132 as shown in FIG. 6. The ear-hook 100 can be employed substantially as described above with respect to the ear-hook 10 of FIGS. 1-4.

Although the ear-hook 100 is illustrated with a loop-shaped outer portion 132/inner portion 134, it should be understood that the spring member 124 could be employed ear-hooks having alternative shapes, such as a closed hook as shown in FIGS. 1-4.

As illustrated in FIG. 7, operations according to embodiments of the present invention include providing a substantially auriform ear-hook having an outer portion configured to face generally away from an ear of the user and a compressible inner portion configured to face generally toward the ear (Block 200). The inner portion of the ear-hook can be compressed (Block 210). For example, a user can grasp and compress the ear-hook inner portion before or during the placement of the ear-hook on the ear. The user can engage the ear with the ear-hook in the compressed position such that the inner portion automatically expands to an expanded position that exerts a force on the ear of the user and conforms the ear-hook to the ear (Block 220). Examples of various expanded positions of the inner portion 34 of the ear-hook 30 are illustrated in FIGS. 1-6.

The earphone housing 20 can include electronics for headset operations known to those of skill in the art. For example, the earphone housing 20 can include speaker electronics and/or communication electronics, such as Bluetooth® short-range wavelength communication electronics or conventional wired communications via the optional wired connection 40. It should be understood that the earphone 10 can be used with various electronic devices with audio capabilities, such as personal wirelessly enabled digital assistants (personal data assistants (PDAs), such as Palm Pilot™ or Pocket PC™ devices), cellular telephones and/or data terminals, pagers, wireless messaging devices (such as a Blackberry™ wireless handheld device), laptop computers, wireless enabled laptop computers, table top computers, land-line telephones, music players such as MP3 players, other mobile communications/audio devices and/or combinations thereof.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An adjustable ear-hook earphone comprising:
an audio earphone; and
a substantially auriform ear-hook connected to the earphone and configured to engage an ear of a user to hold the earphone adjacent the ear, the ear-hook having an outer portion configured to face generally away from the ear and a compressible inner portion configured to face generally toward the ear, the inner portion being compressible between a compressed position and a plurality of successive, expanded positions such that the expanded positions exert a force on the ear of the user.

2. The adjustable ear-hook earphone of claim 1, wherein the outer portion of the ear-hook is substantially rigid.

3. The adjustable ear-hook earphone of claim 1, wherein the inner portion is configured to expand to one of the plurality of successive, expanded positions to substantially conform the earhook to more than one differently sized ear.

4. The adjustable ear-hook earphone of claim 1, wherein the outer portion is formed of a first material and the inner portion is formed of a second material that is different from the first material.

5. The adjustable ear-hook earphone of claim 4, wherein the second material is foam.

6. The adjustable ear-hook earphone of claim 1, wherein the audio earphone is configured to communicate with a cellular phone.

7. The adjustable ear-hook earphone of claim 1, wherein the audio earphone housing includes a speaker.

8. The adjustable ear-hook earphone of claim 1, wherein the inner portion comprises an elongated member that extends along a length substantially parallel to the outer portion of the ear-hook.

9. The adjustable ear-hook earphone of claim 8, wherein the inner portion is configured to compress and expand in a direction substantially normal to the ear-hook.

10. An adjustable ear-hook assembly, comprising:
a substantially auriform ear-hook configured to be connected to an earphone housing and further configured to engage an ear of a user to hold the earphone adjacent the ear, the ear-hook having an outer portion configured to face generally away from the ear and a compressible inner portion configured to face generally toward the ear, the inner portion being compressible between a compressed position and a plurality of successive, expanded positions such that the expanded positions exert a force on the ear of the user.

11. The adjustable ear-hook assembly of claim 10, wherein the outer portion of the ear-hook is substantially rigid.

12. The adjustable ear-hook assembly of claim 10, wherein the inner portion is configured to expand to one of the plurality of successive, expanded positions to substantially conform the earhook to more than one differently sized ear.

13. The adjustable ear-hook assembly of claim 10, wherein the outer portion is formed of a first material and the inner portion is formed of a second material that is different from the first material.

14. The adjustable ear-hook assembly of claim 13, wherein the second material is foam.

15. The adjustable ear-hook assembly of claim 1, wherein the inner portion comprises an elongated member that extends alone a length substantially parallel to the outer portion of the ear-hook.

16. The adjustable ear-hook assembly of claim 15, wherein the inner portion is configured to compress and expand in a direction substantially normal to the ear-hook.

17. A method for adjusting an adjustable ear-hook, the method comprising:
providing a substantially auriform ear-hook having an outer portion configured to face generally away from an ear of the user and a compressible inner portion configured to face generally toward the ear;
compressing the inner portion of the ear-hook; and
engaging the ear of the user with the ear-hook such that the inner portion automatically expands from a compressed position to an expanded position that exerts a force on the ear of the user and conforms the ear-hook to the ear.

18. The method of claim 17, wherein the outer portion of the ear-hook is substantially rigid.

19. The method of claim 1, wherein the inner portion is configured to automatically expand to one of the plurality of successive, expanded positions to substantially conform the earhook to more than one differently sized ear.
